(19) United States
(12) Patent Application Publication
(10) Pub. No.: US 2011/0171844 A1
(43) Pub. Date: Jul. 14, 2011

(54) CONNECTOR

(76) Inventor: Yen-Lin CHEN, Wugu Township (TW)

(21) Appl. No.: 12/686,580

(22) Filed: Jan. 13, 2010

(51) Int. Cl. H01R 13/62

(52) U.S. Cl. 439/260

(57) ABSTRACT

The present invention relates to a connector, including a case, a terminal and a pressing member. The terminal is provided with a fixed arm fixed to the case and a movable arm juxtaposed so as to extend in the same direction. One end of the movable arm has a press portion, and another end has a portion to be pressed. The pressing member has a rotating shaft, and a pressure bearing portion able to press the portion to be pressed is directionally formed thereon. Because the pressure bearing portion able to press the portion to be pressed is directionally formed on the rotating shaft of the pressing member and able to bear pressure on the portion to be pressed of the terminal, thus the present invention effectively prevents the pressing member from breaking off or damage resulting when the pressing member is subjected to an inappropriate reverse direction operation.

### BACKGROUND OF THE INVENTION

(a) Field of the Invention

The present invention relates to a connector for application in electrical connections of flexible circuit boards, and more particularly to a connector having a structure which is firmer and safer.

(b) Description of the Prior Art

In order to enable flexible circuit boards to achieve electric connection effectiveness, normally such flexible circuit boards are connected to a connector, the connector comprising a case, terminals and a pressing member. When the pressing member of the connector is moved, then the pressing member is enabled to move the terminals, thereby causing the terminals to press on the flexible circuit board.

Referring to FIG. 1, which shows an implementation schematic view of a connector of the prior art, in which a connector 1 of the prior art comprises a case 11, a terminal 12, and a pressing member 13. The terminal 12 comprises a fixed arm 121 and a movable arm 122 juxtaposed so as to extend in the same direction, and the fixed arm 121 is fixed to the case 11. One end of the movable arm 122 is provided with a clamping portion 123, while another end is provided with a portion to be pressed 124. Moreover, the fixed arm 121 is connected to the movable arm 122 using a connecting portion 125 to form a single body, and the pressing member 13 is provided with a cam 131.

Using the aforementioned structure enables a force to be exerted to move the pressing member 13 and cause the pressing member 13 to displace towards a predetermined direction, whereupon the cam 131 of the pressing member 13 upwardly pushes the portion to be pressed 124. Moreover, angular displacement of the movable arm 122 is effected using the connecting portion 125 as a pivot, causing the cam 131 of the pressing member 13 to prop up and support the portion to be pressed 124 of the movable arm 122, thereby causing the clamping portion 123 to compress downward.

However, the following problems and shortcomings are still in need of improvement when using the aforementioned connector 1 of the prior art:

A gap is presented between the portion to be pressed 124 and the terminal 12 prior to the compressing operation of the cam 131 of the pressing member 13, and if a reverse direction force is exerted on the pressing member 13 through misoperation, then the pressing member 13 may break off or damage may result.

Hence, it is the strong desire of the inventor and manufacturers engaged in related art and purpose of the present invention to research, improve and resolve the problems and shortcomings of the aforementioned prior art.

### SUMMARY OF THE INVENTION

Hence, in light of the shortcomings of the aforementioned prior art, the inventor of the present invention, having collected related data, and through evaluation and consideration from many aspects, as well as having accumulated years of experience in related arts, through continuous testing and improvements, has designed a new connector having a structure which is firmer and safer.

The primary objective of the present invention lies in providing a connector for flexible circuit boards having a structure which is firmer and safer.

In order to achieve the above objective, a connector of the present invention comprises a case, a terminal and a pressing member. The terminal is provided with a fixed arm and a movable arm juxtaposed so as to extend in the same direction. One end of the movable arm is provided with a press portion, while another end is provided with a portion to be pressed. The fixed arm is fixedly secured using the case, and the pressing member is provided with a rotating shaft. A pressure bearing portion able to press the portion to be pressed is directionally formed on the rotating shaft.

In which the pressing member is subjected to a displacement operation to present an open state and a pressed-together state. When the pressing member presents an open state, then the portion to be pressed of the terminal assumes a contact state with the pressure bearing portion. Moreover, when the pressing member is subjected to a displacement operation to effect displacement towards a predetermined direction, then the pressure bearing portion of the pressing member enables pressing the portion to be pressed of the movable arm, thereby causing the movable arm to serve as a lever to effect angular displacement and present a pressed-together state.

Because the pressure bearing portion able to press the portion to be pressed is directionally formed on the rotating shaft of the pressing member, thus, when the pressing member is in an open state, then the pressure bearing portion is used to contact the portion to be pressed of the pressing member, thereby restricting the range of movement of the pressing member. Accordingly, the present invention is able to prevent inappropriate reverse operation of the pressing member, which would otherwise cause the pressing member to break off. Using the connector structure of the present invention, when the pressing member is subjected to an inappropriate reverse operation, then stress on the rotating shaft causing a rotating force is canceled by the pressure bearing portion of the portion to be pressed, thereby effectively preventing the pressing member from springing out because of the inappropriate operation.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is an implementation schematic view of a connector of the prior art.

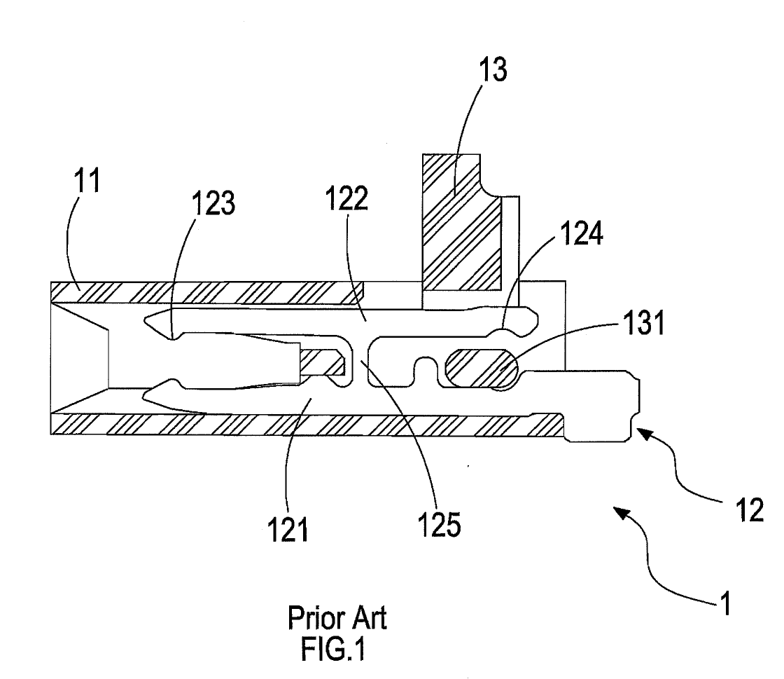

FIG. 2 is an elevational view of a preferred embodiment of the present invention.

FIG. 3 is a cutaway view of the preferred embodiment of the present invention.

FIG. 4 is an implementation schematic view (I) of the preferred embodiment of the present invention.

FIG. 5 is an implementation schematic view (II) of the preferred embodiment of the present invention.

### DETAILED DESCRIPTION OF THE PREFERRED EMBODIMENTS

In order to achieve the aforementioned objectives and effectiveness, the diagrams depicting the preferred embodiments of the present invention and the detailed description of the characteristics and functions thereof follow, whereby the technological means and structure used in the present invention can be completely understood.

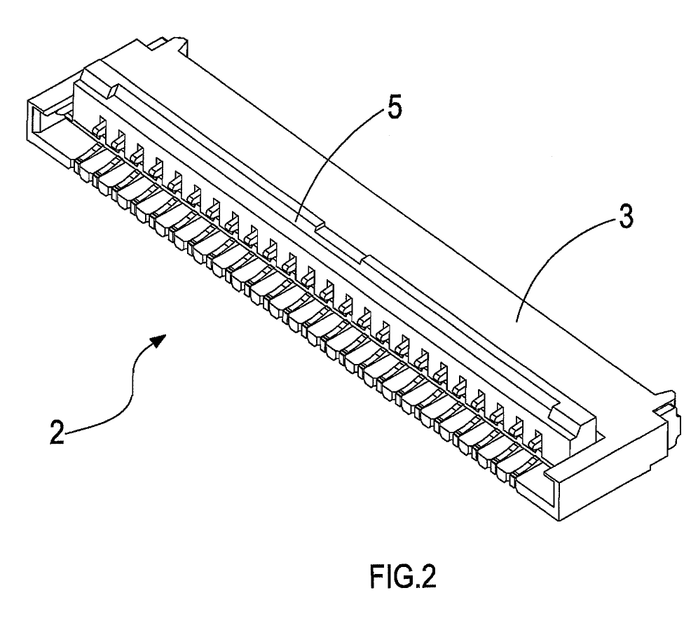

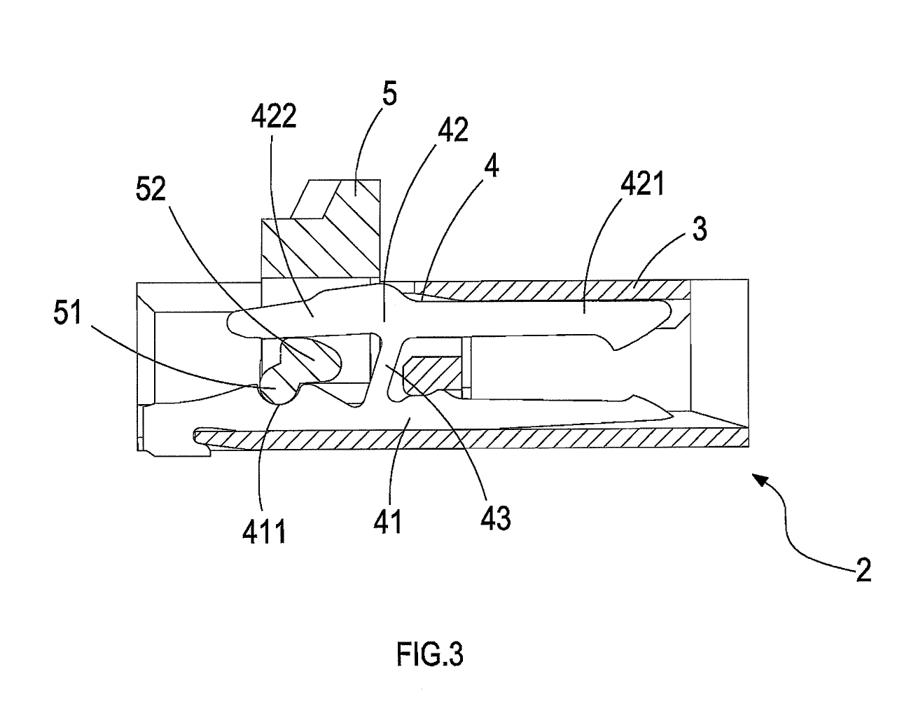

Referring to FIG. 2 and FIG. 3, which show an elevational view and a cutaway view respectively of a preferred embodiment of the present invention, and it can be clearly seen from the drawings that a connector 2 of the present invention comprises:

A case 3.

A terminal 4, and the terminal 4 is provided with a fixed arm 41 and a movable arm 42, which are juxtaposed so as to extend towards the same direction, wherein one end of the movable arm 42 is provided with a press portion 421, while another end is provided with a portion to be pressed 422. The fixed arm 41 is fixedly secured using the case 3, and a groove 411 able to house a rotating shaft 51 is formed in one side of the fixed arm 41. The movable arm 42 and the fixed arm 41 use a connecting portion 43 to form a structural member. The connecting portion 43 is disposed at an angle.

A pressing member 5, and the pressing member 5 is provided with the rotating shaft 51. A pressure bearing portion 52 able to press the portion to be pressed 422 is directionally formed on the rotating shaft 51.

The pressing member 5 is subjected to a displacement operation to present an open state and a pressed-together state. When the pressing member 5 presents an open state, then the portion to be pressed 422 of the terminal 4 assumes a contact state with the pressure bearing portion 52. Moreover, when the pressing member 5 is subjected to a displacement operation to effect displacement towards a predetermined direction, then the pressure bearing portion 52 of the pressing member 5 is able to press the portion to be pressed 422 of the movable arm 42, thereby causing the movable arm 42 to serve as a lever to effect angular displacement and present a pressed-together state.

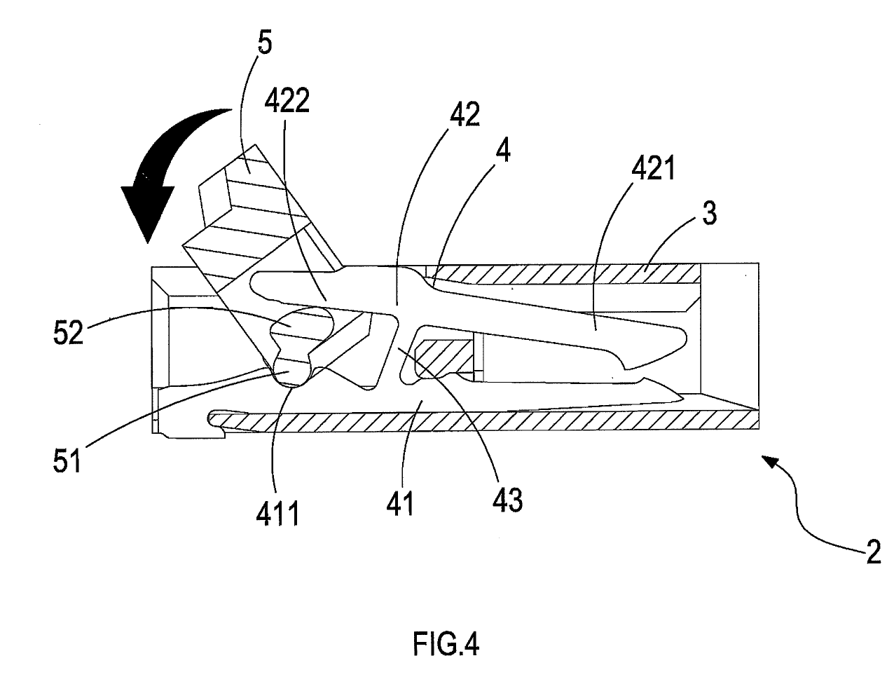

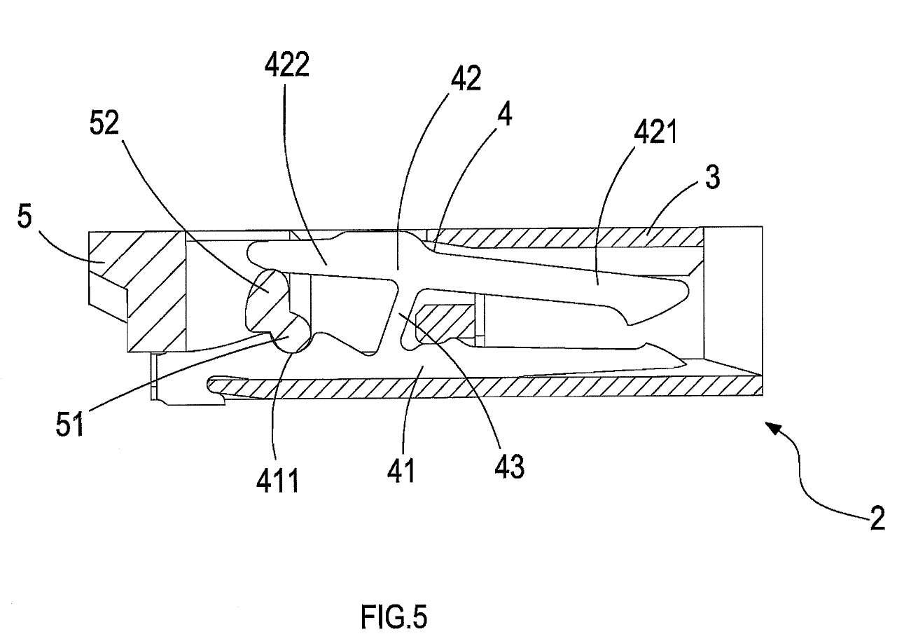

According to the aforementioned structure and constructional design, the circumstances during operational use of the present invention are described hereinafter. Referring simultaneously to FIG. 4 and FIG. 5, which show implementation schematic views (I) and (II) respectively of the preferred embodiment according to the present invention, and it can be clearly seen from the drawings that the connector 2 of the present invention is subjected to a displacement operation and presents an open state and a pressed-together state. When the present invention assumes an open state, because the pressure bearing portion 52 enables pressing the portion to be pressed 422 directionally formed on the rotating shaft 51 of the connector 2 of the present invention, thus, the pressure bearing portion 52 is caused to assume a contact state with the portion to be pressed 422 of the terminal 4. Accordingly, pressure bearing of the portion to be pressed 422 is able to cancel a rotating force produced when the pressing member 5 is subjected to an inappropriate operation in a reverse direction, thereby effectively preventing the pressing member 5 from springing out because of the inappropriate operation or causing damage.

When the pressing member 5 is subjected to a displacement operation towards a predetermined direction, then the pressure bearing portion 52 of the pressing member 5 presses the portion to be pressed 422 of the movable arm 42, thus causing the movable arm 42 to serve as a lever to effect an angular displacement and present a pressed-together state, thereby enabling press fitting of electronic components such as flexible circuit boards, and the like.

Hence, referring to all the drawings, compared to the prior art, the following advantages exist when using the present invention:

The pressure bearing portion 52 able to press the portion to be pressed 422 is directionally formed on the rotating shaft 51 of the connector 2 of the present invention, and when the pressing member 5 is in an open state, then disposition of the pressure bearing portion 52 is used to contact and press the portion to be pressed 422 of the terminal 4, thereby restricting the range of movement of the pressing member 5. When a reverse direction force inappropriately operates the pressing member 5, then the portion to be pressed 422 of the terminal 4 is used to cancel the reverse direction force, thereby preventing the pressing member 5 from breaking off because of the inappropriate operation or causing damage.

In conclusion, the connector of the present invention is clearly able to achieve the effectiveness and objectives as disclosed when in use, and is indeed a practical and exceptional invention that complies with the essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A connector, comprising:
a case;
a terminal, the terminal is provided with a fixed arm and a movable arm juxtaposed so as to extend towards the same direction, wherein one end of the movable arm is provided with a press portion, another end is provided with a portion to be pressed, the fixed arm is fixedly secured using the case;
a pressing member, the pressing member is provided with the rotating shaft, a pressure bearing portion able to press the portion to be pressed is directionally formed on the rotating shaft;
the pressing member is subjected to a displacement operation to present an open state and a pressed-together state, when the pressing member presents an open state, then the portion to be pressed of the terminal assumes a contact state with the pressure bearing portion, moreover, when the pressing member is subjected to a displacement operation to effect displacement towards a predetermined direction, then the pressure bearing portion of the pressing member presses the portion to be pressed of the movable arm, thereby causing the movable arm to serve as a lever to effect angular displacement and present a pressed-together state.

2. The connector according to claim 1, wherein a groove able to house the rotating shaft is formed in one side of the fixed arm.

3. The connector according to claim 1, wherein the movable arm and the fixed arm use a connecting portion to form a structural member.

4. The connector according to claim 3, wherein the connecting portion is disposed at an angle.
